(19) United States
(12) Patent Application Publication
(10) Pub. No.: US 2025/0343601 A1
(43) Pub. Date: Nov. 6, 2025

(54) BLIND ANOMALY DETECTION IN DENSE WAVE DIVISION MULTIPLEXED ROUTED OPTICAL NETWORKS

(71) Applicant: Cisco Technology, Inc., San Jose, CA (US)

(72) Inventors: Claudio Crognale, Monza (MB) (IT); Enrico Sozio, Monza (MB) (IT); Pietro Invernizzi, Varese (IT); Giovanni Martinelli, Monza (MB) (IT); Roberto Manzotti, Vaprio d’Adda (MI) (IT)

(21) Appl. No.: 18/655,538

(22) Filed: May 6, 2024

(51) Int. Cl. H04B 10/079

(52) U.S. Cl. CPC H04B 10/0795

(57) ABSTRACT

A method to detect anomalies in optical channel is provided. The method includes detecting, at an optical terminal node, optical communication metrics for a plurality of optical channels, clustering optical channels in the plurality of optical channels according to the optical communication metrics to obtain a plurality of optical channel clusters, detecting anomalous behavior of a given optical channel in a given cluster of the plurality of optical channel clusters based on a predetermined deviation of at least one of a derivative of the optical communication metrics and an integral of the derivative of the optical communication metrics, and in response to detecting anomalous behavior, communicating an indication of the anomalous behavior on the given optical channel to a network controller.

### TECHNICAL FIELD

The present disclosure relates to optical networks and, more particularly, to methodologies to detect anomalies in a dense wave division multiplexed routed optical network.

### BACKGROUND

The arrangement and deployment of an optical network may be implemented by several different and unrelated actors. For example, in some cases, one manufacturer's products may be used to manage terminal nodes of an optical network, while another manufacturer's products or management tools may be used to control the overall optical network. As an example, a given manufacturer's router, equipped with that same given manufacturer's optical interfaces, may be used in a third-party managed optical network. The optical network may be implemented as, e.g., a DWDM (dense wave division multiplexed) coherent comb of channels that are aggregated and routed along the network.

Without any control over the link between the nodes, it may be difficult for the given manufacturer of the router to know if/where anomalies may be occurring in the network. Moreover, even in the case where a given manufacturer or management actor has total control over all aspects of the optical network, it may still be difficult to efficiently detect anomalies, identify a possible root cause therefor and provide appropriate feedback to a user or to, e.g., a network controller, in such a way to allow possible subsequent ameliorative actions.

### BRIEF DESCRIPTION OF THE DRAWINGS

FIG. 1 shows an optical network including an optical router that may host, or operate in conjunction with, blind anomaly detection logic, according to an example embodiment.

FIG. 2 shows channel clustering based on predetermined metrics and calculated metric centroids, according to an example embodiment.

FIG. 3 is a graph showing metric distributions, according to an example embodiment.

FIG. 4 is a graph showing anomaly detection, according to an example embodiment.

FIG. 5 shows an optical network in which blind anomaly detection logic was executed, according to an example embodiment.

FIG. 6A-1 and FIG. 6A-2 are graphs generated by blind anomaly detection logic showing PreFEC BER evolution along sampling, when a fast power loss is introduced at the receiver side on a group of channels, according to an example embodiment.

FIG. 6B-1 and FIG. 6B-2 are graphs generated by blind anomaly detection logic showing Delta-PreFEC BER evolution along sampling, after the occurrence of the fast power loss, according to an example embodiment.

FIG. 7A is a zoomed graph of FIG. 6A-1 generated by blind anomaly detection logic showing the PreFEC BER versus sample, when a fast power loss is introduced at the receiver side on the whole group of channels, according to an example embodiment.

FIG. 7B is a zoomed graph of FIG. 6B-1 generated by blind anomaly detection logic showing the PreFEC BER variation (i.e., the Delta PreFEC BER) versus sample, after the occurrence of the fast power loss, according to an example embodiment.

FIG. 8A is a graph generated by blind anomaly detection logic showing the PreFEC BER evolutions of a group of channels in presence of a slow X-Talk impairment occurring on a given channel (slow dynamics), according to an example embodiment.

FIG. 8B is a graph generated by blind anomaly detection and amelioration logic showing anomalies in the unbiased PreFEC BER (i.e., the Incremental Derivatives) evolution of the same group of channels shown in FIG. 8A (slow dynamics), according to an example embodiment.

FIG. 9 is a flowchart depicting a series of steps executed by blind anomaly detection and amelioration logic, according to an example embodiment.

FIG. 10 is a block diagram of a computing device that may be configured to host blind anomaly detection and amelioration logic, and to perform techniques described herein, according to an example embodiment.

### DETAILED DESCRIPTION

### Overview

A method to detect anomalies in optical channels and provide appropriate feedback to a user or to a network controller is provided. The method includes detecting, at an optical terminal node, optical communication metrics for a plurality of optical channels, clustering optical channels in the plurality of optical channels according to the optical communication metrics to obtain a plurality of optical channel clusters, detecting anomalous behavior of a given optical channel in a given cluster of the plurality of optical channel clusters based on a predetermined deviation of at least one of a derivative of the optical communication metrics and an integral of the derivative of the optical communication metrics, and in response to detecting anomalous behavior, communicating an indication of the anomalous behavior on the given optical channel a network controller.

A device is also described and includes an interface configured to enable network communications, a memory, and one or more processors coupled to the interface and the memory, and configured to: detect, at an optical terminal node, optical communication metrics for a plurality of optical channels, cluster optical channels in the plurality of optical channels according to the optical communication metrics to obtain a plurality of optical channel clusters, detect anomalous behavior of a given optical channel in a given cluster of the plurality of optical channel clusters based on a predetermined deviation of at least one of a derivative of the optical communication metrics and an integral of the derivative of the optical communication metrics, and in response to detecting anomalous behavior, communicate an indication of the anomalous behavior on the given optical channel to a network controller.

### EXAMPLE EMBODIMENTS

Embodiments described herein are configured to identify anomalies on optical channels by observing data coming from terminal nodes and transmitting/receiving interfaces. That is, the embodiments are configured such that there is no need to have knowledge of how optical links in a network are managed (in terms of, e.g., amplifiers/wavelength switches, etc.). In other words, the techniques described herein are configured to identify anomalies in a unique fashion, and, as appropriate, enable a proper alert to a user or appropriate network controller. Identifying anomalies is performed “blind” to the makeup or configuration of the optical links that feed a given terminal node at which techniques are applied.

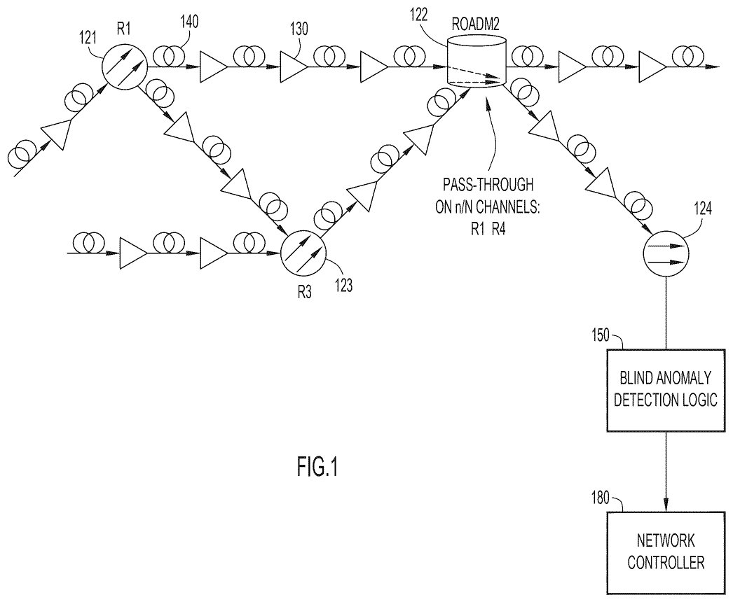

Reference is now made to FIG. 1, which shows an optical network 100 including an optical router that may host, or operate in conjunction with, blind anomaly detection logic 150, according to an example embodiment. In the figure, optical network 100 includes router R1 121, reconfigurable optical add/drop module, or ROADM2 122, router R3 123, and router R4 124 (which may be considered a terminal node for purposes of this description), and optical line amplifiers 130, all in communication with one another via optical fiber 140. In this case, blind anomaly detection logic 150 is in communication with router R4 124, which, as illustrated, receives, as an example, n/N optical channels of a DWDM optical signal from router R1 121. Some of the n/N optical channels (signals) may pass directly through ROADM2 122, and other of the n/N optical channels may first pass through router R3 123.

In accordance with an embodiment, blind anomaly detection logic 150 considers a given number n/N of channels at a terminal node, e.g., router R4 124, casually distributed along the C-Band spectrum, with each channel being characterized by a given channel center frequency and a channel-ID (identifier) and—for sake of simplicity and without loss of generality—having a same traffic mode, e.g., same line or baud rate.

In an embodiment, an assumption is made that, during “normal” running (i.e., when no anomaly occurs), channels (optical signals) coming from the same node (i.e., passing through the same path, e.g., router R1 121 to router R4 124), can exhibit different values of metrics, but only similar variations of the metrics around their average values, when collected in a same time slot. In other words, channels traveling along the same path can have different absolute performances (due to gain tilt/ripple, wavelength-dependence, and so on), but will likely have comparable fluctuations of the metrics. This assumption, together with monitoring of other parameters (e.g., the chromatic dispersion (CD) of the channels, the polarization dependent loss (PDL), the Line-Rate/Bit Rate, and so forth), enables blind anomaly detection logic 150 to statistically infer the path and anomalies occurring thereon for one or more channels.

In accordance with one implementation, blind anomaly detection logic 150 clusters channels based on performance metrics (PMs) and derivatives thereof, and then detects anomalies within channel clusters using the derivatives and integrated values of the derivatives (referred to herein as “Incremental Derivatives”. More specifically, blind anomaly detection logic 150 may be configured to derive a distribution of metric variations (and/or integrated metric variations) vs. channel-ID. In this way, as will be explained below, the metric variations (and/or the integrated metric variations) become the real metric processed for anomaly detection, and not the absolute values of a given metric itself.

In an embodiment, blind anomaly detection logic 150 creates groups (i.e., clusters) of channels having different absolute performances, but with comparable metric fluctuations.

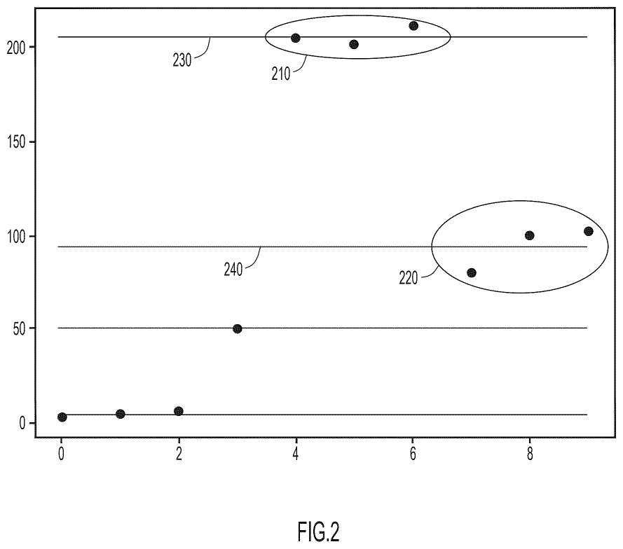

For each cluster, a centroid may be derived. In this way, the reference value of the metric is derived according to an agnostic, statistical approach, and not as a single value. A further check on, e.g., the chromatic dispersion (CD), temperature, Line-Rate/BR, carrier frequencies and so forth may be performed, to statistically enforce and confirm the clustering result. For example, as shown in FIG. 2, the illustrated dots or channel groupings 210, 220 represent channel clusters (for given metrics) and the horizontal lines 230, 240 represent centroids for those metric clusters. Monitored metrics may include, e.g., bit error rate variations and/or integrated metric variations (before (forward) error correction), received signal strength or power, CD, polarization dependent loss (PDL), optical signal to noise ratio (OSNR), and modulation. Thus, for example, the channel grouping 210 (channels 4, 5, 6) might be grouped due to similarly high CD, and channel grouping 220 (channels 7, 8, 9) might be grouped together due to similarly high PreFEC BER (pre-forward error correction bit error rate) fluctuations. Those skilled in the art will appreciate that clustering can be made based on multiple performance metrics, not just a single performance metric. Thus, the values on the Y-axis would be germane to the metric(s) on which clustering may be based.

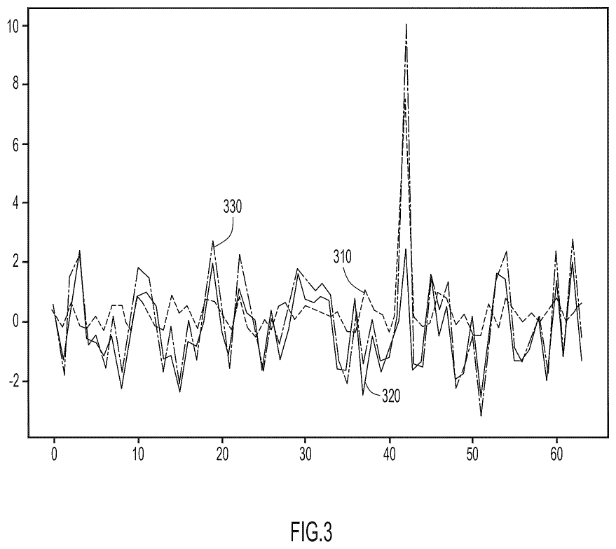

As shown in FIG. 3, variations 310 for channels, or metric distributions, in each cluster are compared with a threshold or baseline 320, consistent with a value of, e.g., a previously revealed centroid. Plot 330 represents a next step or time window over which the performance metrics are being monitored.

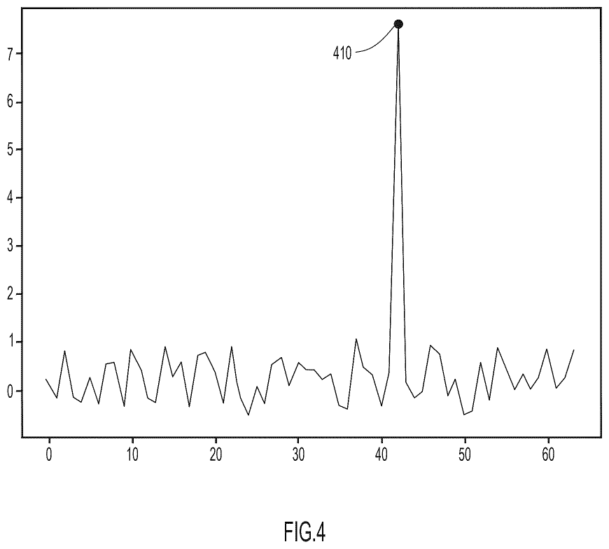

As shown in FIG. 4, an anomaly 410 is detected if the channel variation (in this case for, e.g., channel 42) exceeds the threshold.

It is noted that metric variations and integrated metric variations can also be checked and compared to a threshold channel-by-channel at each time slot in a parallel fashion, without necessarily comparing to previously generated centroid.

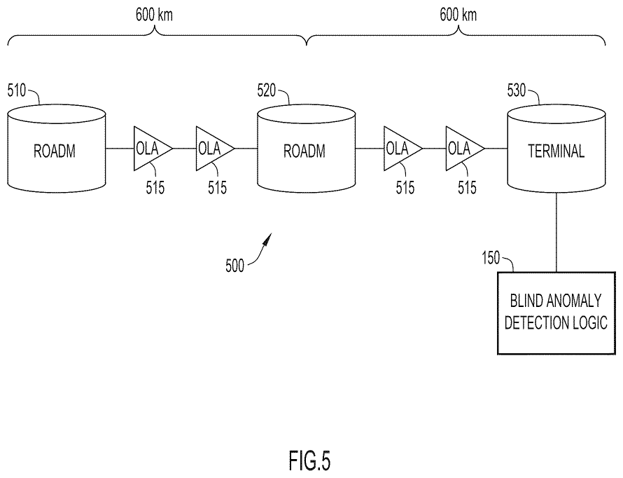

FIG. 5 shows an optical network 500 in which blind anomaly detection logic 150 may be executed, according to an example embodiment. In this example, a ROADM 510 is in communication with ROADM 520 via a fiber link including optical line amplifiers or OLAs 515, and ROADM 520 is in communication with terminal 530 via a fiber link including OLAs 515. As shown, the distance between each major component is 600 km. In one experiment, seven interfaces (e.g., pluggable modules, not shown) were dropped after the entire 1200 km path, and five interfaces were dropped after the first 600 km link. Anomalies were generated by introducing impairments in the link (e.g., producing cross talk on one or more adjacent channels, or decreasing the optical channel powers at the receiver side).

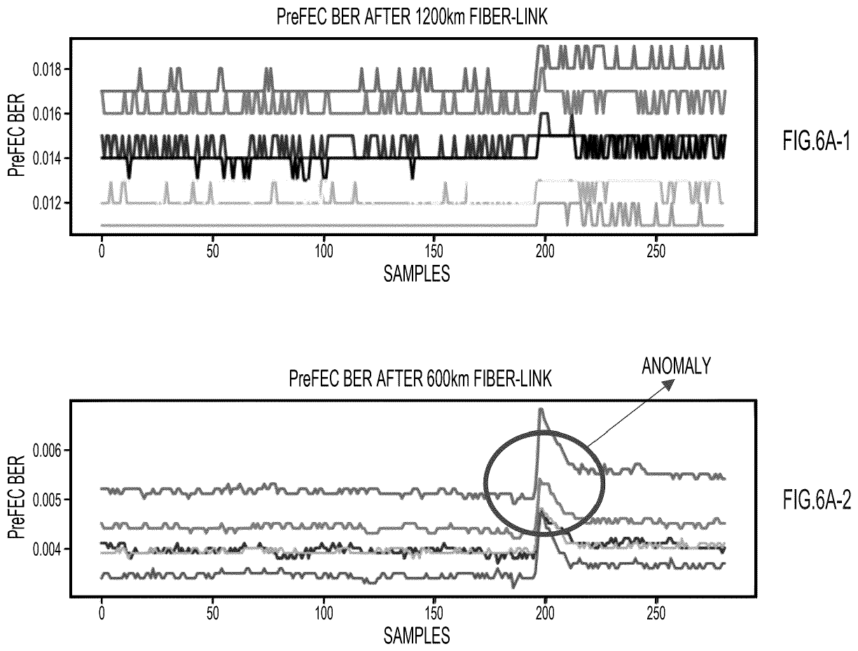

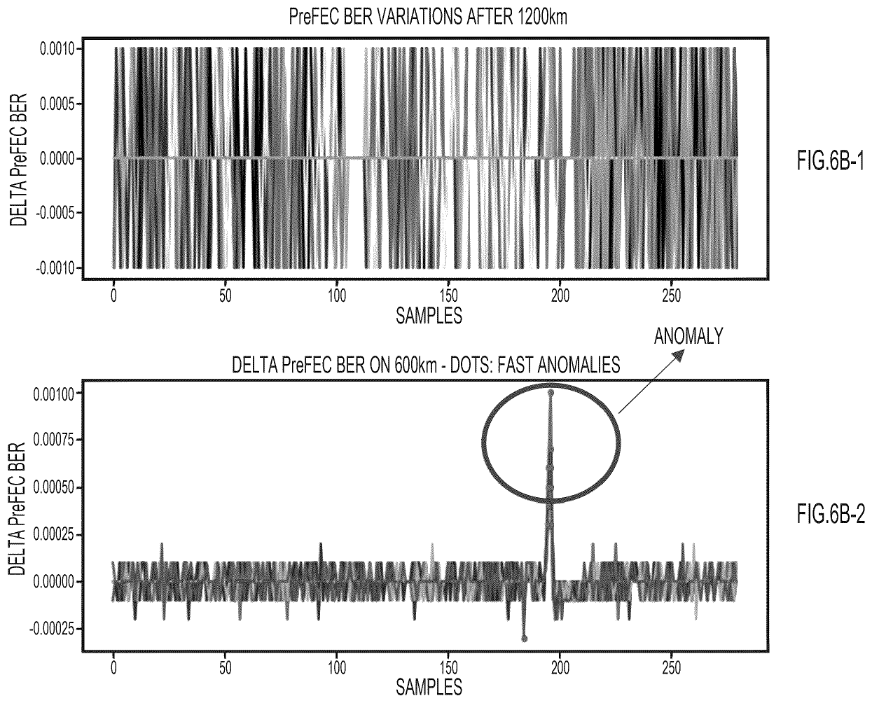

FIG. 6A-1 and FIG. 6A2 are graphs generated by blind anomaly detection logic 150 showing PreFEC BER evolution versus samplings, according to an example embodiment. FIG. 6A-1 shows the PreFEC BER evolution of the channels dropped after 1200 km of fiber, whereas FIG. 6A-2 reports the same metric evolution for channels dropped after 600 km. As can be seen, anomalies are detected on each one of channels dropped after 600 km. The anomalies were produced by introducing a fast decrement power loss at the receiver side on the whole group of channels. The same anomalies are shown in FIG. 6B-1 and FIG. 6B-2, where the PreFEC BER variations (i.e., the derivatives of the original metric) have been used to detect them. FIG. 6B-represents the 1200 km-dropping, whereas FIG. 6B-2 shows the result in the case of the 600 km-dropping. The high sensitivity of the derivative with respect to the fast dynamics of the impairment causing the anomalies on the channels is evident from FIG. 6B-2. Moreover, the amount of the fluctuations (the peak-to-peak deltas) in the 1200 km-group are evidently very different from those in the 600 km group and, as discussed above, this feature can be exploited to improve the clustering procedure.

More details regarding the structure and operations of blind anomaly detection logic 150 are provided next. Blind anomaly detection logic 150 may be viewed as having four main features:
(1) Introduction of two new metrics derived from one or more (perhaps all) physical metrics available from receiver monitors and/or the parameters to process data;
(2) Clustering;
(3) Anomaly detection with the two metrics derived from one or more parameters available from receiver monitors; and
(4) Anomaly identification, e.g., feedback to a user (or network controller 180) in an effort to prevent potential catastrophic events and restore the optical network 100 to normal system running.

Each is described next.

### (1) Introduction of Two New Metrics to Process Data

Blind anomaly detection logic 150 is configured to exploit two new metrics, derived from the absolute values of physical metrics (e.g., PreFEC BER, RX-Power, etc.) used to monitor optical channels/signals.

The first metric or parameter is obtained from derivatives of the physical metrics (to manage fast dynamics). As a practical example, consider the data distributions reported in the graphs of FIGS. 6A-2 and 6B-2 (i.e., the 600 km-dropping test case). In this configuration, before the anomaly occurs, the average values of the PreFEC BER (shown in FIG. 6A-2) for the five channels are: 0.0041, 0.0045, 0.0052, 0.0039, 0.0034. Because of the impact of the optical link (amplifier tilt, frequency carriers spreading along C-Band, and so on), the values of the PreFEC BER result differ from each other and spread along the channel group. The derivatives, on the other hand, are instead always centered around zero, thus removing the intrinsic bias of the channels, and enabling the tracing back to a single reference value. The same situation is obtained considering the remaining channels, dropped after 1200 km (FIG. 6A-1). The average values of the PreFEC BER for the seven channels (before anomaly) are in fact: 0.015, 0.017, 0.014, 0.017, 0.012, 0.013, 0.011, with an evident PreFEC BER spreading within the corresponding group, whereas the derivatives are still all centered around zero.

Another feature emerging from the figures is the amount of the derivative variations in the two groups of channels. As shown in FIG. 6A-1, most of channels dropped after 1200 km exhibit a Delta PreFEC BER of the order of ±0.001, whereas channels belonging to the other ensemble (FIG. 6A-2) show a Delta PreFEC BER of around ±0.0001. This phenomenon can be exploited to create two distinct clusters, only considering this metric. Moreover, as introduced above, CD, Line Rates and Baud Rates can be also added to the procedure as further parameters to enforce and better discriminate the clusters. This strategy can be particularly useful especially in some cases such as, for example, in presence of limited accuracy of a receiver's monitor, e.g., unable to properly measure the fast variations of a given metric (a limit, in this example, depending on the characteristic of the pluggable, and then not to be considered as a limitation of the new metric).

Finally, and in connection with FIGS. 6B-2 and 7B, the derivatives of the 600 km-group of channels in correspondence of a fast decrement of the received powers, it is noted that the derivatives of all channels suddenly increase, revealing a strong and fast anomaly on all channels belonging to the same cluster. This demonstrates the effectiveness of the new metric to detect fast abnormal events.

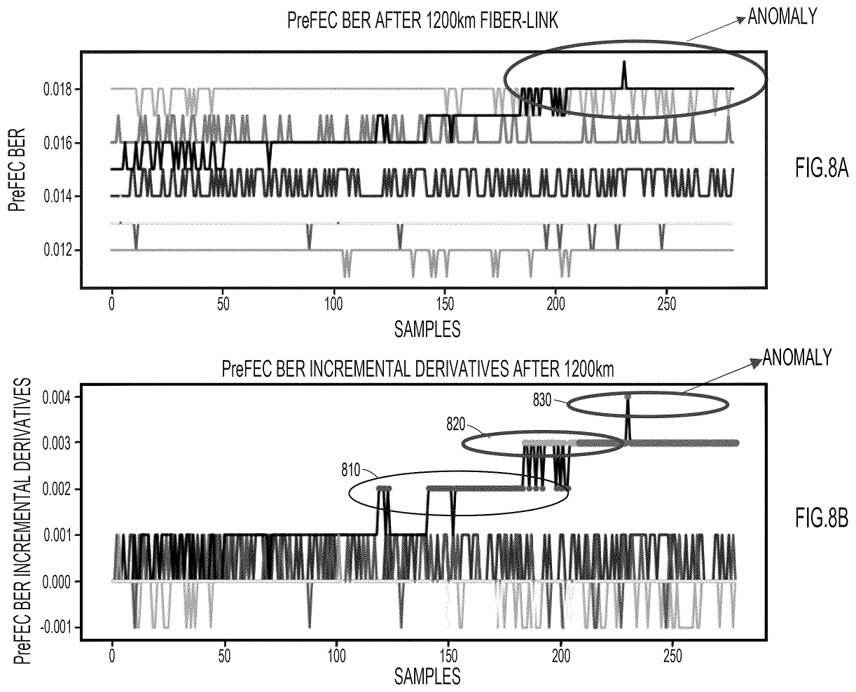

The second metric or parameter is referred to as “Incremental Derivatives,” i.e., the integrated derivatives of physical metrics (to manage slow dynamics). The effectiveness of this new metric is visible in FIGS. 8A and 8B. In this case, considered are the PreFEC BER evolution of the 1200 km-dropping channels group in presence of a slow progressive PreFEC BER degradation due to a X-Talk produced on the black channel. The initial average values of the PreFEC BER for the seven channels (before anomaly) are similar to those reported above: 0.014, 0.016, 0.015, 0.018, 0.013, 0.013, 0.012. Because of the X-Talk, the PreFEC BER of the black channel slowly drifts from 0.015 to 0.018 and, given the slow dynamic of the impairment, a better result for the anomaly detection is obtained by using the second metric, i.e. the Incremental Derivatives (FIG. 8B). In fact, it is to be noted that, in a similar way to the derivative, this metric removes the bias of the physical metric and reproduces the slow drift of the physical metric with a good accuracy. This enables blind anomaly detection logic 150 to easily compare at any time the metric with the corresponding threshold previously defined and detect the anomaly in a very effective way.

As an example, this technique has been applied with the following strategy: (1) The centroids of the channel derivatives and incremental derivatives are calculated and averaged for a reference time-series, obtained from data recording without any impairment; (2) For each one of the two metrics, a first PreFEC BER threshold value (Low-Threshold) is defined as the average upper bound found by calculating the quantiles and the IQR of the distances from the centroids derived by data without any impairment. This threshold is used to identify an anomalous event, but it could correspond to a false positive. (3) A second PreFEC BER threshold value (High-Threshold) is defined for each one of the two metrics as the product of a proper coefficient multiplied by the first PreFEC BER threshold value previously found. This threshold may be used to select the real anomalies and reject the false positives, according to a statistical procedure. (4) All abnormal events collected are statistically evaluated by progressively calculating the corresponding quantiles and IQR values and comparing the upper-bounds derived at each step with the High-Threshold. The event is classified as an anomaly when the upper-bounds exceed the High-Threshold. The results of this strategy are shown in FIG. 8B. Dots 810 in the Incremental derivatives distribution represent false positives that overcome the Low-Threshold but cannot be considered as “dangerous” events. Dots 820 represent anomalies that overcome the High-Threshold and are considered as “real” abnormal events but might not reasonably indicate a catastrophic event. Finally, dot 830 represent events occurring applying the statistical analysis and identify a dangerous anomaly on the black channel.

### (2) Clustering

Blind anomaly detection logic 150 is configured, as noted earlier, to group and process channels according to their performances and impairments. The evaluation of the channel performances/impairments and then the clustering creation is performed by using the derivatives and Incremental Derivatives mentioned above. Other parameters and/or metrics may also be used, as those skilled in the art will appreciate.

(3) Anomaly Detection with the Two Metrics/Parameters

In accordance with an embodiment, anomaly detection is performed by blind anomaly detection logic 150 in each cluster by using the performance metrics data available at the terminal nodes, in a blind way, i.e., without knowing details regarding the links in between network nodes, and without relying on a control plane or a network controller. The anomaly detection is performed by exploiting the derivatives and Incremental Derivatives, noted above.

### (4) Anomaly Identification, e.g., Feedback to a User (or Network Controller 180) in an Effort to Prevent Potential Catastrophic Events and Restore the Optical Network 100 to Normal System Running

In the event an anomaly is detected, blind anomaly detection logic 150 may be configured to communicate with, e.g., network controller 180 (FIG. 1) or an administrator to identify impacted channel(s), and, perhaps, provide a further indication of an ameliorative action that could be performed to eliminate or diminish the anomalous behavior, e.g., suggest changing an optical path for a given channel.

As noted, the embodiments described herein aim to detect and identify anomalies in a blind way, i.e., by using only the PMs data available at the terminal nodes, without knowing any detail of the links in between the nodes and without having any control on the elements between the terminal nodes. Despite this limitation, the strategy and embodiments described above can be used to give proper feedback to the user or network controller 180 to allow possible subsequent actions. For example, consider the case of FIGS. 8A and 8B. As explained above, the root cause of the anomaly is a progressive X-Talk on the black channel in the 1200 km-cluster. Just after revealing a suspect anomaly (i.e., in correspondence of a first dot in dots 820), blind anomaly detection logic 150 starts checking metrics and parameters over time. If the anomaly is identified as “true” and potentially dangerous (i.e., in correspondence of a first dot in dots 830), an operator may be advised that an anomaly is occurring on the indicated channel.

In the meantime, during the data checking process, blind anomaly detection logic 150 records that the carrier frequency of one of the two channels adjacent to the indicated one is progressively moving towards it, whereas the carrier frequency of the indicated channel is stable. This data is reported to the user or network controller 180, giving a hint about possible subsequent actions. In this way, the user can promptly act on the system and prevent a potentially catastrophic event from occurring.

As a further example, consider as root cause of the anomaly a progressive decrement of received powers of a group of channels in a cluster at the terminal node. In this case, after detecting and verifying the occurrence of the anomaly, the blind anomaly detection logic 150 may report to the user or network controller 180 the kind of anomaly (i.e., the loss of power at the receiver side), the clusters and the channels impacted, and communicate the proper operation to perform on the network.

As noted, the creation of the clusters and the detection of the anomalies are based on the fluctuations of the metrics, and then from the exploitation of the two noted parameters:
The derivatives of the metrics (that quantify the fluctuations, and are used to detect fast-dynamics anomalies); and
The “Incremental Derivatives” of the metrics (i.e., the integral of the derivatives, that are used to detect slow-dynamics anomalies).

Both of these operations are performed on the metrics monitored by blind anomaly detection logic 150. The derivatives can be derived by choosing any step-size, according to the sampling time and the dynamics of the system.

The introduction of both these processing operations on data allows removing the bias (i.e., the constant values of the metrics vs. time) of the metrics in each channel of the WDM comb and analyzing in parallel the evolution of these parameters in real time by using a single, common value of threshold for each parameter, valid for all channels belonging to a centroid, enhancing the effectiveness of both the clustering and the detection process.

As an example embodiment, the occurrence of the anomalies in the channel groups can be derived by using a threshold for each one of the two parameters (e.g., defined with respect to a reference situation without any impairment), exploiting any deterministic or statistical approach suitable for the target.

Finally, the capability of using other data available from PMs such as, for example, CD, PMD, temperature, channel frequencies, Line Rates, Baud Rates, etc., or the exploitation of other techniques to perform averages or tracking or prediction of the parameters objects of the invention (e.g., Kalman filtering, or any other tracking/predictive algorithm, or the adjustment of the reference points for the thresholds) may also be leveraged along with reliance on the derivatives and Incremental Derivatives.

Thus, in operation, blind anomaly detection logic 150 may, over repeating time windows, derive:

(1) A distribution of metric variations vs. channel-ID, obtained by numerically calculating the derivatives of predetermined metrics available from monitors (at, e.g., Router R4 124, FIG. 1 or terminal 530, FIG. 5).

(2) A distribution of integrated metric variations (the “Incremental Derivatives”) vs. channel-ID, obtained numerically by integrating the derivatives of the metrics.

(3) A distribution of “other data” vs. each channel-ID, as available from monitors, such as Line Rates, Baud Rates, CD, Channel Frequencies, Temperatures, etc.

Blind anomaly detection logic 150 then creates groups (i.e., clusters) of channels having different absolute performances, but with comparable metric fluctuations and without different biases, in a stable working condition. The clustering process can be enforced by exploiting the “other data”.

For each cluster, blind anomaly detection logic 150 derives a centroid using a statistical procedure. As an example, the cluster creation and the centroid derivation can be performed by exploiting metric data-recorded in a given temporal window-without any impairment, i.e., in a normal running condition, considered as a reference distribution for a statistical analysis. This operation can be repeated during the running of the system, in order to update in real-time the reference distributions of the parameters.

One or more thresholds for each one of the derivatives and the Incremental Derivatives belonging to the distributions are then defined by blind anomaly detection logic 150. Thresholds can be introduced in a deterministic or statistical way. As an example, thresholds can be statistically defined as the average upper bound found by calculating the quartiles and the interquartile range (IQR) from the distances from the centroids, previously derived. More than one value of threshold can be introduced, for each parameter in the distributions, to, e.g., avoid the occurrence of false positives.

Channel derivatives and Incremental Derivatives in each cluster may then be compared with the derived thresholds, depending on the amount of the centroid previously found.

In operation, blind anomaly detection logic 150 identifies an anomaly if the channel variation (derivative of metric) and/or the channel Incremental Derivative exceeds the threshold. In another—more complex—example, a statistical pattern analysis in each group can be added to the threshold approach, to enforce the effectiveness of the procedure and identify the real anomalies, rejecting apparent false positives. A tracking or predictive approach (by using a Kalman filtering, or any other ML techniques, applied to the distributions) can be also considered, to improve the effectiveness of the procedure.

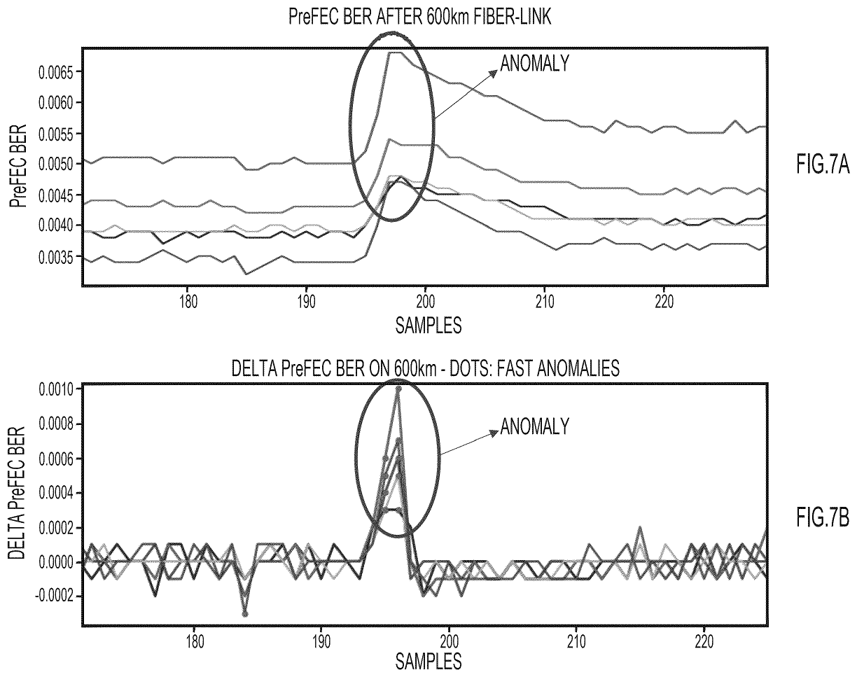

Reference is again made to FIG. 7A, which is a graph generated by blind anomaly detection logic 150 showing PreFEC BER versus sample index, when a fast power loss is introduced at the receiver side on the whole group of channels, according to an example embodiment. More specifically, the graphs of FIGS. 7A and 7B is are a zoomed in version of FIGS. 6A-2 and 6B-2 showing the samples of where anomalous behavior has been detected. FIG. 7B is a zoomed in graph generated by blind anomaly detection logic 150 showing Delta PreFEC BER versus sample index, according to an example embodiment. Both of these graphs show the fluctuations of the indicated metric over time.

FIG. 8A is a graph generated by blind anomaly detection logic 150 showing PreFEC BER variations (slow dynamics), according to an example embodiment.

FIG. 8B is a graph generated by blind anomaly detection logic 150 showing anomalies in the unbiased PreFEC BER (i.e., the Incremental Derivatives) variations (slow dynamics), according to an example embodiment.

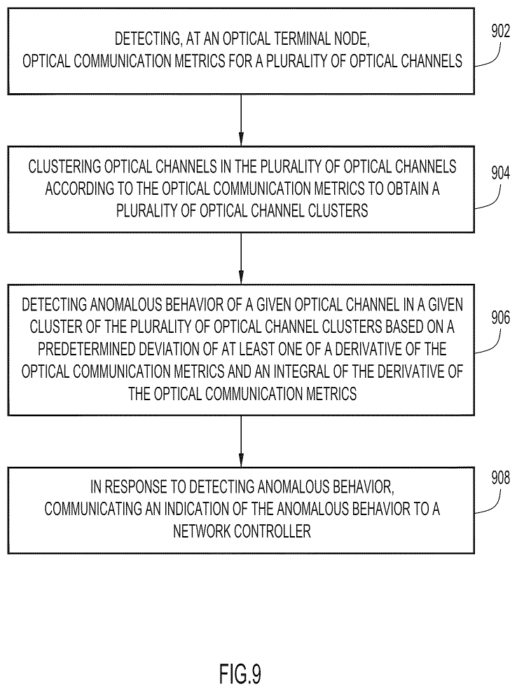

FIG. 9 is a flowchart showing a series of operations that may be performed by blind anomaly detection logic 150, according to an example embodiment. At 902, an operation includes detecting, at an optical terminal node, optical communication metrics for a plurality of optical channels. At 904, an operation includes clustering optical channels in the plurality of optical channels according to the optical communication metrics to obtain a plurality of optical channel clusters. At 906, an operation includes detecting anomalous behavior of a given optical channel in a given cluster of the plurality of optical channel clusters based on a predetermined deviation of a value of one or more of the optical communication metrics from at least one of a derivative of the optical communication metrics and an integral of the derivative of the optical communication metrics. And, at 908, an operation includes in response to detecting anomalous behavior, communicating an indication of the anomalous behavior to a network controller.

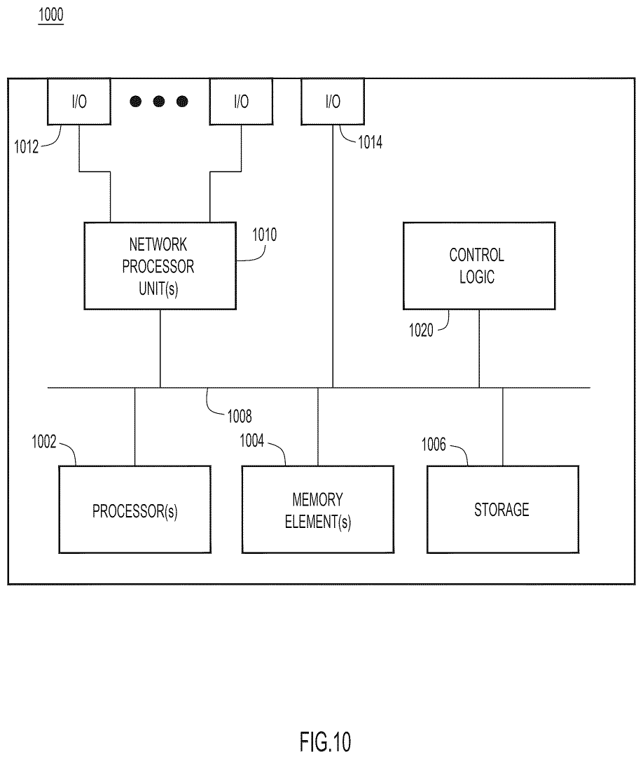

FIG. 10 is a block diagram of a computing device that may be configured to host blind anomaly detection logic 150, and perform techniques described herein, according to an example embodiment. In various embodiments, a computing device, such as computing device 1000 or any combination of computing devices 1000, may be configured as any entity/entities as discussed for the techniques depicted in connection with FIGS. 1-9 in order to perform operations of the various techniques discussed herein.

In at least one embodiment, the computing device 1000 may include one or more processor(s) 1002, one or more memory element(s) 1004, storage 1006, a bus 1008, one or more network processor unit(s) 1010 interconnected with one or more network input/output (I/O) interface(s) 1012, one or more I/O interface(s) 1014, and control logic 1020 (which could include blind anomaly detection logic 150). In various embodiments, instructions associated with logic for computing device 1000 can overlap in any manner and are not limited to the specific allocation of instructions and/or operations described herein.

In at least one embodiment, processor(s) 1002 is/are at least one hardware processor configured to execute various tasks, operations and/or functions for computing device 1000 as described herein according to software and/or instructions configured for computing device 1000. Processor(s) 1002 (e.g., a hardware processor) can execute any type of instructions associated with data to achieve the operations detailed herein. In one example, processor(s) 1002 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 1004 and/or storage 1006 is/are configured to store data, information, software, and/or instructions associated with computing device 1000, and/or logic configured for memory element(s) 1004 and/or storage 1006. For example, any logic described herein (e.g., control logic 1020) can, in various embodiments, be stored for computing device 1000 using any combination of memory element(s) 1004 and/or storage 1006. Note that in some embodiments, storage 1006 can be consolidated with memory element(s) 1004 (or vice versa) or can overlap/exist in any other suitable manner.

In at least one embodiment, bus 1008 can be configured as an interface that enables one or more elements of computing device 1000 to communicate in order to exchange information and/or data. Bus 1008 can be implemented with any architecture designed for passing control, data and/or information between processors, memory elements/storage, peripheral devices, and/or any other hardware and/or software components that may be configured for computing device 1000. In at least one embodiment, bus 1008 may be implemented as a fast kernel-hosted interconnect, potentially using shared memory between processes (e.g., logic), which can enable efficient communication paths between the processes.

In various embodiments, network processor unit(s) 1010 may enable communication between computing device 1000 and other systems, entities, etc., via network I/O interface(s) 1012 (wired and/or wireless) to facilitate operations discussed for various embodiments described herein. In various embodiments, network processor unit(s) 1010 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 1000 and other systems, entities, etc. to facilitate operations for various embodiments described herein. In various embodiments, network I/O interface(s) 1012 can be configured as one or more Ethernet port(s), Fibre Channel ports, any other I/O port(s), and/or antenna(s)/antenna array(s) now known or hereafter developed. Thus, the network processor unit(s) 1010 and/or network I/O interface(s) 1012 may include suitable interfaces for receiving, transmitting, and/or otherwise communicating data and/or information in a network environment.

I/O interface(s) 1014 allow for input and output of data and/or information with other entities that may be connected to computing device 1000. For example, I/O interface(s) 1014 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 1020 can include instructions that, when executed, cause processor(s) 1002 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 1020) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 1004 and/or storage 1006 can store data, software, code, instructions (e.g., processor instructions), logic, parameters, combinations thereof, and/or the like used for operations described herein. This includes memory element(s) 1004 and/or storage 1006 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### VARIATIONS AND IMPLEMENTATIONS

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

In sum, a method may include detecting, at an optical terminal node, optical communication metrics for a plurality of optical channels, clustering optical channels in the plurality of optical channels according to the optical communication metrics to obtain a plurality of optical channel clusters, detecting anomalous behavior of a given optical channel in a given cluster of the plurality of optical channel clusters based on a predetermined deviation of at least one of a derivative of the optical communication metrics and an integral of the derivative of the optical communication metrics, and in response to detecting anomalous behavior, communicating an indication of the anomalous behavior on the given optical channel to a network controller.

In the method, the optical communication metrics may include at least one of bit error rate (BER), pre-forward error correction BER, received signal strength, chromatic dispersion (CD), polarization dependent loss (PDL), optical signal to noise ratio (OSNR), and modulation technique.

In the method, the clustering may include calculating a centroid for the optical communication metrics.

The method may further include sampling the optical communication metrics at a predetermined sampling rate and calculating respective derivatives of the optical communication metrics.

In the method, the clustering may be performed based on the respective derivatives of the optical communication metrics.

In the method, the detecting anomalous behavior may be based on the respective derivatives of the optical communication metrics.

The method may further include integrating the respective derivatives of the optical communication metrics to obtain incremental derivatives.

In the method, the clustering may be performed based on the incremental derivatives.

The method may further include changing an optical path for the given optical channel in response to detecting anomalous behavior.

The method may further include communicating to the network controller an identification of the given optical channel in the given cluster.

In another embodiment, a device may be provided and may include an interface configured to enable network communications, a memory, and one or more processors coupled to the interface and the memory, and configured to: detect, at an optical terminal node, optical communication metrics for a plurality of optical channels, cluster optical channels in the plurality of optical channels according to the optical communication metrics to obtain a plurality of optical channel clusters, detect anomalous behavior of a given optical channel in a given cluster of the plurality of optical channel clusters based on a predetermined deviation of at least one of a derivative of the optical communication metrics and an integral of the derivative of the optical communication metrics, and in response to detecting anomalous behavior, communicate an indication of the anomalous behavior on the given optical channel to a network controller.

In the device, the optical communication metrics may include at least one of bit error rate (BER), pre-forward error correction BER, received signal strength, chromatic dispersion (CD), polarization dependent loss (PDL), optical signal to noise ratio (OSNR), and modulation technique.

In the device, the one or more processors may be further configured to cluster by calculating a centroid for the optical communication metrics.

In the device, the one or more processors may be further configured to sample the optical communication metrics at a predetermined sampling rate and calculate respective derivatives of the optical communication metrics.

In the device, the one or more processors may be further configured to cluster based on the respective derivatives of the optical communication metrics.

In the device, the one or more processors may be further configured to detect anomalous behavior based on the respective derivatives of the optical communication metrics.

In the device, the one or more processors may be further configured to integrate the respective derivatives of the optical communication metrics to obtain incremental derivatives, and to cluster based on the incremental derivatives.

In yet another embodiment, one or more non-transitory computer readable storage media encoded with instructions are provided and that, when executed by a processor, cause the processor to: detect, at an optical terminal node, optical communication metrics for a plurality of optical channels, cluster optical channels in the plurality of optical channels according to the optical communication metrics to obtain a plurality of optical channel clusters, detect anomalous behavior of a given optical channel in a given cluster of the plurality of optical channel clusters based on a predetermined deviation of at least one of a derivative of the optical communication metrics and an integral of the derivative of the optical communication metrics, and in response to detecting anomalous behavior, communicate an indication of the anomalous behavior on the given optical channel to a network controller.

In the one or more non-transitory computer readable storage media, the optical communication metrics may include at least one of bit error rate (BER), received signal strength, chromatic dispersion (CD), polarization dependent loss (PDL), optical signal to noise ratio (OSNR), and modulation technique.

In the one or more non-transitory computer readable storage media, the instructions may be configured to sample the optical communication metrics at a predetermined sampling rate, calculate respective derivatives of the optical communication metrics, and cluster based on the respective derivatives of the optical communication metrics.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method, comprising:
detecting, at an optical terminal node, optical communication metrics for a plurality of optical channels;
clustering optical channels in the plurality of optical channels according to the optical communication metrics to obtain a plurality of optical channel clusters;
detecting anomalous behavior of a given optical channel in a given cluster of the plurality of optical channel clusters based on a predetermined deviation of at least one of a derivative of the optical communication metrics and an integral of the derivative of the optical communication metrics; and
in response to detecting anomalous behavior, communicating an indication of the anomalous behavior on the given optical channel to a network controller.

2. The method of claim 1, wherein the optical communication metrics comprise at least one of bit error rate (BER), pre-forward error correction BER, received signal strength, chromatic dispersion (CD), polarization dependent loss (PDL), optical signal to noise ratio (OSNR), and modulation technique.

3. The method of claim 1, wherein the clustering comprises calculating a centroid for the optical communication metrics.

4. The method of claim 1, further comprising sampling the optical communication metrics at a predetermined sampling rate and calculating respective derivatives of the optical communication metrics.

5. The method of claim 4, wherein the clustering is performed based on the respective derivatives of the optical communication metrics.

6. The method of claim 4, wherein the detecting anomalous behavior is based on the respective derivatives of the optical communication metrics.

7. The method of claim 4, further comprising integrating the respective derivatives of the optical communication metrics to obtain incremental derivatives.

8. The method of claim 7, wherein the clustering is performed based on the incremental derivatives.

9. The method of claim 1, further comprising changing an optical path for the given optical channel in response to detecting anomalous behavior.

10. The method of claim 1, further comprising communicating to the network controller an identification of the given optical channel in the given cluster.

11. A device comprising:
an interface configured to enable network communications;
a memory; and
one or more processors coupled to the interface and the memory, and configured to:
detect, at an optical terminal node, optical communication metrics for a plurality of optical channels;
cluster optical channels in the plurality of optical channels according to the optical communication metrics to obtain a plurality of optical channel clusters;
detect anomalous behavior of a given optical channel in a given cluster of the plurality of optical channel clusters based on a predetermined deviation of at least one of a derivative of the optical communication metrics and an integral of the derivative of the optical communication metrics; and
in response to detecting anomalous behavior, communicate an indication of the anomalous behavior on the given optical channel to a network controller.

12. The device of claim 11, wherein the optical communication metrics comprise at least one of bit error rate (BER), pre-forward error correction BER, received signal strength, chromatic dispersion (CD), polarization dependent loss (PDL), optical signal to noise ratio (OSNR), and modulation technique.

13. The device of claim 11, wherein the one or more processors are further configured to cluster by calculating a centroid for the optical communication metrics.

14. The device of claim 11, wherein the one or more processors are further configured to sample the optical communication metrics at a predetermined sampling rate and calculate respective derivatives of the optical communication metrics.

15. The device of claim 14, wherein the one or more processors are further configured to cluster based on the respective derivatives of the optical communication metrics.

16. The device of claim 14, wherein the one or more processors are further configured to detect anomalous behavior based on the respective derivatives of the optical communication metrics.

17. The device of claim 14, wherein the one or more processors are further configured to integrate the respective derivatives of the optical communication metrics to obtain incremental derivatives, and to cluster based on the incremental derivatives.

18. One or more non-transitory computer readable storage media encoded with instructions that, when executed by a processor, cause the processor to:
detect, at an optical terminal node, optical communication metrics for a plurality of optical channels;
cluster optical channels in the plurality of optical channels according to the optical communication metrics to obtain a plurality of optical channel clusters;
detect anomalous behavior of a given optical channel in a given cluster of the plurality of optical channel clusters based on a predetermined deviation of at least one of a derivative of the optical communication metrics and an integral of the derivative of the optical communication metrics; and
in response to detecting anomalous behavior, communicate an indication of the anomalous behavior on the given optical channel to a network controller.

19. The one or more non-transitory computer readable storage media of claim 18, wherein the optical communication metrics comprise at least one of bit error rate (BER), received signal strength, chromatic dispersion (CD), polarization dependent loss (PDL), optical signal to noise ratio (OSNR), and modulation technique.

20. The one or more non-transitory computer readable storage media of claim 18, wherein the instructions are configured to sample the optical communication metrics at a predetermined sampling rate, calculate respective derivatives of the optical communication metrics, and cluster based on the respective derivatives of the optical communication metrics.
